(19) United States
(12) Patent Application Publication
(10) Pub. No.: US 2026/0191206 A1
(43) Pub. Date: Jul. 9, 2026

(54) SYNERGISTIC INSECTICIDAL COMPOSITION COMPRISING PHTHALIMIDE COMPOUNDS AND THE USE THEREOF

(71) Applicant: COUNCIL OF SCIENTIFIC AND INDUSTRIAL RESEARCH AN INDIAN REGISTERED BODY INCORPORATED UNDER THE REGN., New Delhi (IN)

(72) Inventors: Rakesh Shamsunder JOSHI, Pune (IN); Meenakshi Brian TELLIS, Pune (IN); Sharada Dayanand MOHITE, Pune (IN)

(21) Appl. No.: 19/132,730

(22) PCT Filed: Nov. 16, 2023
(86) PCT No.: PCT/IN2023/051057

§ 371 Date: May 23, 2025

(30) Foreign Application Priority Data
Nov. 25, 2022 (IN) 202211068205

(51) Int. Cl. A01N 65/26; A01N 25/10; A01N 43/38; A01P 7/04

(52) U.S. Cl. CPC A01N 65/26; A01N 25/10; A01N 43/38; A01P 7/04

(57) ABSTRACT

The present invention relates to an insecticidal composition comprising of N-(phenylthio) phthalimide (NPP), neem oil and chitosan and method of preparation thereof. The composition of the present invention is useful against insects selected from Helicoverpa armigera, Mythimna separata, Spodoptera frugiperda and other Lepidopteran species of insects. The composition can serve as a formulation that possesses a lower probability of acquiring resistance.

### FIELD OF THE INVENTION

The present invention generally relates to an insecticidal composition. Specifically, the present invention relates to an insecticidal composition comprising N-(phenylthio) phthalimide (NPP), neem oil and chitosan. The composition of the present invention is useful against insects selected from Helicoverpa armigera, Mythimna separata, Spodoptera frugiperda and other Lepidopteran species of insects.

### BACKGROUND OF THE INVENTION

Background description includes information that may be useful in understanding the present invention. It is not an admission that any of the information provided herein is prior art or relevant to the present invention, or that any publication specifically or implicitly referenced is prior art.

Insect infestation poses serious challenge to agricultural productivity. Insects are showing resistance to existing pesticides, and they are proving to be ineffective in the long run. Furthermore, most of existing insecticide molecules are toxic to humans and there is a need of safer alternatives. The currently available pesticides are very general and affect human metabolism as well when they target insects, e.g., insecticides that are acetyl choline inhibitors. The excessive use of synthetic insecticides leads to resistance in insects. The evolution of resistance to insecticides is a serious and growing concern in the field of agriculture.

In Cross et al (Sci Rep 9, 16165 (2019)), several molecules were evaluated with respect to their potential as trehalose-6-phosphate phosphatases (TPP) inhibitors. N-(Phenylthio) phthalimide (NPP) with molecular formula C₁₄H₉NO₂S is found to inhibit trehalose 6-phosphate phosphatase. An analogue of NPP, i.e., Folpet is a marketed product used as a fungicide. Cross et al reported various phthalimide derivatives and their activities against bacteria, worms and use as anthelmintic drug.

NPP is a synthetic compound with high anthelmintic and anti-insect properties. NPP preserves the environment and poses no risk to human health. NPP costs less than pesticides and is recommended for organic farming. It has no phytotoxicity or human toxicity, a crucial parameter for taking a molecule to the market.

The neem tree, a tropical evergreen, has been used for centuries as a source of pesticides to which insects have not developed a resistance. Various neem seed extracts, particularly the ones containing the hydrophilic, tetranortriterpenoid, and azadirachtin, are known to influence the feeding behavior, metamorphosis (insect growth regulating IGR) effect, fecundity, and fitness of numerous insect species belonging to various orders.

Therefore, there is an un-met need in the art to provide a non-toxic insecticidal composition to control agricultural pests like Helicoverpa armigera, Mythimna separata, Spodoptera frugiperda and other Lepidopteran insects. Also, there is a need to provide an insecticidal combination composition that is effective and controls the pests or insects that are resistant to current existing synthetic insecticide. Also, there is need to develop a combination of insecticidal compositions that possesses a lower probability of acquiring resistance.

### OBJECTIVES OF THE INVENTION

An objective of the present invention is to provide an insecticidal composition that is effective, ecofriendly, controls the pests or insects that are resistant to current existing synthetic insecticide and itself has lower probability of acquiring resistance.

Another objective of the present invention is to provide an insecticidal formulation showing activity against Helicoverpa armigera, Mythimna separata, Spodoptera frugiperda and other Lepidopteran insects.

Another objective of the present invention is to provide an insecticidal composition comprising NPP, chitosan and neem oil.

Yet another objective of the present invention is to provide a process for preparation of the insecticidal composition comprising NPP, chitosan and neem oil.

### SUMMARY OF THE INVENTION

This summary is provided to introduce a selection of concepts in a simplified form that are further described below in Detailed Description section. This summary is not intended to identify key features or essential features of the subject matter, nor is it intended to be used as an aid in determining the scope of the subject matter.

The present invention relates to an insecticidal composition comprising N-(phenylthio) phthalimide (NPP), neem oil and chitosan. The composition of the present invention is useful against insects selected from Helicoverpa armigera, Mythimna separata, Spodoptera frugiperda and other Lepidopteran species of insects.

In an aspect, the present invention relates to an insecticidal composition comprising:
a) N-(phenylthio) phthalimide (NPP);
b) Dimethyl sulphoxide (DMSO;
c) Sodium tripolyphosphate;
d) chitosan;
e) neem oil; and
f) optionally agriculturally acceptable excipients.

In another aspect, the present invention relates to an insecticidal composition comprising:
a) N-(phenylthio) phthalimide (NPP) in an amount in a range of 0.025% to 0.11% by total weight of the composition;
b) DMSO and sodium tripolyphosphate present in range of 0.4 to 0.5% by total weight of the composition;
c) chitosan present in an amount in a range of 0.89% to 1.10% by total weight of the composition;
d) neem oil in an amount in a range of 0.09% to 0.11% by total weight of the composition; and
e) optionally agriculturally acceptable excipients.

In another aspect of the present invention, the agriculturally acceptable excipient is selected from suspending agent, anti-foaming agent, anti-freezing agent, preservatives, thickeners, solvents, emulsifiers, stabilizers, wetting-spreading-penetrating agents, buffering agents, carriers, disintegrating agents and a combination thereof.

In another aspect of the present invention, the composition effectively controls agricultural pests like Helicoverpa armigera, Mythimna separata, Spodoptera frugiperda and other Lepidopteran insects.

In another aspect of the present invention, the composition has a synergistic effect.

In another aspect, the present invention relates to a process of preparation of the insecticidal formulation comprising combination of:
a) chitosan;
b) neem oil;
c) N-(phenylthio) phthalimide (NPP);
d) Dimethyl sulphoxide (DMSO);
e) Sodium tripolyphosphate; and
f) optionally agriculturally acceptable excipients.

In another aspect, the present invention relates to a process of preparation of the insecticidal formulation comprising the steps of:
a adding 0.89-1.10% by weight of chitosan to 1-3% acetic acid and stirring the mixture for over-night at room temperature (25-30° C.) to obtain chitosan solution;
b) dissolving N-(phenylthio) phthalimide 0.025% and 0.5% in 200 μl dimethyl sulfoxide (DMSO) and then adding to the chitosan solution obtained in step a) to obtain a solution;
c) adding 0.09-0.5% neem oil to the solution of step b) and stirring the solution at room temperature (25-30° C.) to obtain a homogenous mixture;
d) adding 10 ml of polyanionic cross-linking agents like sodium tripolyphosphate, sodium pyrophosphate, tetra polyphosphate, octapolyphosphate, hexametaphosphate, sodium alginate, k-carrageenan, octyl sulfate, dodecyl sulfate, hexadecyl sulfate, and cetyl-stearyl sulfate dropwise to the homogenous mixture of step c) and stirring the mixture until it is homogenized at room temperature (25-30° C.) to obtain a formulation solution; and
e) sonicating the formulation solution obtained in step d) as required to obtain a nanoparticle solution of insecticidal composition.

In yet another aspect, the present invention relates to a method of controlling insects, wherein the method comprises applying the composition of the present invention.

Various objects, features, aspects, and advantages of the inventive subject matter will become more apparent from the following detailed description of preferred embodiments. These and other features, aspects, and advantages of the present subject matter will be better understood with reference to the following description and appended claims. This summary is provided to introduce a selection of concepts in a simplified form. This summary is not intended to identify key features or essential features of the claimed subject matter, nor is it intended to be used to limit the scope of the claimed subject matter.

### BRIEF DESCRIPTION OF THE DRAWINGS

The following drawings form a part of the present specification and are included to further illustrate aspects of the present disclosure. The disclosure may be better understood by reference to the drawings in combination with the detailed description of the specific embodiments presented herein.

FIG. 1 illustrates comparative percent mortality of Spodoptera frugiperda (Day-8) upon treatment with composition of the present invention and individual ingredients, in accordance with an embodiment of the present disclosure.

FIG. 2 depicts comparative survival analysis of the effect of composition of present invention on Spodoptera frugiperda, in accordance with an embodiment of the present disclosure.

FIG. 3 depicts the effect of composition of present invention on insect body weight, in accordance with an embodiment of the present disclosure.

### DETAILED DESCRIPTION OF THE INVENTION

The following is a detailed description of embodiments of the disclosure. The embodiments are in such detail as to clearly communicate the disclosure. However, the amount of detail offered is not intended to limit the anticipated variations of embodiments; on the contrary, the intention is to cover all modifications, equivalents, and alternatives falling within the spirit and scope of the present disclosure as defined by the appended claims.

Those skilled in the art will be aware that the present disclosure is subject to variations and modifications other than those specifically described. It is to be understood that the present disclosure includes all such variations and modifications.

The disclosure also includes all such steps, features, compositions, and compounds referred to or indicated in this specification, individually or collectively, and any and all combinations of any or more of such steps or features.

### Definitions

For convenience, before further description of the present disclosure, certain terms employed in the specification, and examples are delineated here. These definitions should be read in light of the remainder of the disclosure and understood as by a person of skill in the art. The terms used herein have the meanings recognized and known to those of skill in the art, however, for convenience and completeness, particular terms and their meanings are set forth below.

The term “at least one” is used to mean one or more and thus includes individual components as well as mixtures/combinations.

Throughout this specification, unless the context requires otherwise the word “comprise”, and variations such as “comprises” and “comprising”, will be understood to imply the inclusion of a stated element or step or group of element or steps but not the exclusion of any other element or step or group of element or steps.

The term “including” is used to mean “including but not limited to”. “including” and “including but not limited to” are used interchangeably.

Unless the context requires otherwise, throughout the specification which follow, the word “comprise” and variations thereof, such as, “comprises” and “comprising” are to be construed in an open, inclusive sense that is as “including, but not limited to.”

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable.

The recitation of ranges of values herein is merely intended to serve as a shorthand method of referring individually to each separate value falling within the range. Unless otherwise indicated herein, each individual value is incorporated into the specification as if it is individually recited herein.

All processes described herein can be performed in any suitable order unless otherwise indicated herein or otherwise clearly contradicted by context. The use of any and all examples, or exemplary language (e.g., “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

The headings and abstract of the invention provided herein are for convenience only and do not interpret the scope or meaning of the embodiments.

The following discussion provides many example embodiments of the inventive subject matter. Although each embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed.

All publications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

Various terms are used herein. To the extent a term used in a claim is not defined below, it should be given the broadest definition persons in the pertinent art have given that term as reflected in printed publications and issued patents at the time of filing.

As used herein, the term “insecticide’ is intended to encompass insect repellents, larvacides, ovicides and the like.

As used herein, the term “chitosan” refers to a linear polysaccharide composed of randomly distributed D-glucosamine (deacetylated unit) and N-acetyl-D glucosamine (acetylated unit). Chitosan is produced by deacetylation of chitin. The term, “chitosan” relates to chitosan, chitosan derivatives and mixtures of chitosan and chitosan derivatives.

In a general embodiment, the present invention relates to an insecticidal composition comprising a combination of N-(phenylthio) phthalimide (NPP), neem oil and chitosan. The insecticidal formulation shows activity against insects selected from Helicoverpa, Spodoptera and other Lepidopteran species of insects.

In an embodiment, the present invention relates to an insecticidal formulation comprising:
(a) N-(phenylthio) phthalimide (NPP);
(b) DMSO;
(c) sodium tripolyphosphate;
(d) chitosan;
(e) neem oil; and
(f) optionally agriculturally acceptable excipients.

In another embodiment of the present invention, the chitosan and other bio-based nano-material is present in the form of nanoparticles.

In another embodiment of the present invention, the neem and chitosan are present in the form of emulsion, oil and so on.

In another embodiment of the present invention, the N-(phenylthio) phthalimide and its derivatives present in the form of nanoparticles.

In another embodiment of the present invention, the NPP is present in an amount in a range of 0.025% to 0.11% by weight of the composition. Preferably, the NPP is present in an amount of 0.1%.

In another embodiment of the present invention, the neem oil is present in an amount in a range of 0.09% to 1.5% by weight of the composition. Preferably, the neem oil is present in an amount of 0.1%

In another embodiment of the present invention, the chitosan is present in an amount in a range of 0.89% to 1.10% by weight of the composition. Preferably, the chitosan is present in an amount of 1%.

In another embodiment, the present invention relates to an insecticidal composition comprises:
a) N-(phenylthio) phthalimide (NPP) present in an amount of 0.1% by total weight of the composition;
b) DMSO and sodium tripolyphosphate present in range of 0.4 to 0.5% by total weight of the composition;
c) chitosan present in an amount of 0.1% by total weight of the composition;
d) neem oil in an amount in a range of 1% by total weight of the composition; and
e) optionally agriculturally acceptable excipients.

In another embodiment of the present invention, emulsion concentrate (ECs) formulations usually contain an oil-soluble liquid active ingredient, a petroleum-based solvent, and an emulsifier (mixing agent). The emulsifier allows the active ingredient in the solvent to mix with water and forms emulsion. ECs are versatile formulations that can be applied with many types of sprayers.

In another embodiment of the present invention, the insecticidal composition comprising a combination of ingredients which individually are relatively effective to a lesser extent, but act in concert to provide high total killing power with a substantially decreased kill time.

In another embodiment of the present invention, the insecticidal formulation control agricultural pests like Helicoverpa armigera, Mythimna separata, Spodoptera frugiperda and other Lepidopteran insects. The molecules and its derivatives used in the formulation are not regarded as a health hazard under current legislation and do not show any phytotoxicity.

In an embodiment of the present invention, the combination composition shows a Synergistic effect.

In another embodiment of the present invention, the composition can be effective against Helicoverpa armigera, Spodoptera frugiperda and other lepidopteran species.

In another embodiment of the present invention, the composition is effective against H. armigera or other lepidopteran insects.

In an embodiment, the present disclosure provides a composition that can be effective in resistance management in insects, pests and mites by delaying or preventing the resistance development against the composition.

In an embodiment, the present disclosure provides a composition that can increase or possess the broad-spectrum activities against insects, pests and mites by targeting insects, pests and mites by controlling their feeding ability by chewing, sucking or piercing.

In an embodiment, the present disclosure relates to a formulation comprising of chitosan, neem oil, N-(phenylthio) phthalimide (NPP); and optionally agriculturally acceptable excipients.

The insecticidal composition of the present invention may be prepared by mixing chitosan, neem oil and N-(phenylthio) phthalimide (NPP) as active ingredients, with various agricultural additives/excipients in accordance with conventional formulation methods for agricultural chemicals, and applied in various formulations such as dusts, granules, water dispersible granules, wettable powders, tablets, pills, capsules (including a formulation packaged by a water soluble film), water-based suspensions, oil-based suspensions, microemulsions, suspoemulsions, water soluble powders, emulsifiable concentrates, soluble concentrates or pastes. It may be formed into any formulation which is commonly used in this field, so long as the object of the present invention is thereby met.

The additives/excipients to be used for the formulation include, for example, a solid carrier such as kaolinite, sericite, diatomaceous earth, slaked lime, calcium carbonate, talc, white carbon, kaolin, bentonite, clay, sodium carbonate, sodium bicarbonate, mirabilite, zeolite or starch; a solvent such as water, toluene, xylene, solvent naphtha, dioxane, dimethylsulfoxide, N,N-dimethylformamide, dimethylacetamide, N-methyl-2-pyrrolidone or an alcohol; an anionic surfactant such as a salt of fatty acid, a benzoate, a polycarboxylate, a salt of alkylsulfuric acid ester, an alkyl sulfate, an alkylaryl sulfate, an alkyl diglycol ether sulfate, a salt of alcohol sulfuric acid ester, an alkyl sulfonate, an alkylaryl sulfonate, an aryl sulfonate, a lignin sulfonate, an alkyldiphenylether disulfonate, a polystyrene sulfonate, a salt of alkylphosphoric acid ester, an alkylaryl phosphate, a styrylaryl phosphate, a salt of polyoxyethylene alkyl ether sulfuric acid ester, a polyoxyethylene alkylaryl ether sulfate, a salt of polyoxyethylene alkylaryl ether sulfuric acid ester, a polyoxyethylene alkyl ether phosphate, a salt of polyoxyethylene alkylaryl phosphoric acid ester, a salt of polyoxyethylene aryl ether phosphoric acid ester, a naphthalene sulfonic acid condensed with formaldehyde or a salt of alkylnaphthalene sulfonic acid condensed with formaldehyde; a nonionic surfactant such as a sorbitan fatty acid ester, a glycerin fatty acid ester, a fatty acid polyglyceride, a fatty acid alcohol polyglycol ether, acetylene glycol, acetylene alcohol, an oxyalkylene block polymer, a polyoxyethylene alkyl ether, a polyoxyethylene alkylaryl ether, a polyoxyethylene styrylaryl ether, a polyoxyethylene glycol alkyl ether, polyethylene glycol, a polyoxyethylene fatty acid ester, a polyoxyethylene sorbitan fatty acid ester, a polyoxyethylene glycerin fatty acid ester, a polyoxyethylene hydrogenated castor oil or a polyoxypropylene fatty acid ester; and a vegetable oil or mineral oil such as olive oil, kapok oil, castor oil, palm oil, camellia oil, coconut oil, sesame oil, corn oil, rice bran oil, peanut oil, karanj oil, cottonseed oil, soybean oil, rapeseed oil, linseed oil, tung oil or liquid paraffins. These additives may suitably be selected for use alone or in combination as a mixture of two or more of them, so long as the object of the present invention is met. Further, additives other than the above-mentioned may be suitably selected for use among those known in this field. For example, various additives commonly used, such as a filler, a thickener, an anti-settling agent, an anti-freezing agent, a dispersion stabilizer, a safener, an anti-mold agent, a bubble agent, a disintegrator and a binder, may be used.

In a specific embodiment, the formulation may be a solid or semi-solid formulation. In an embodiment, the formulation may be selected from the group comprising of capsule suspension (CS), dispersible concentrate (DC), emulsifiable concentrate (EC), emulsion, water in oil (EO), emulsion, oil in water (EW), jambo balls or bags (bags in water soluble pouch), micro-emulsion (ME), oil dispersion (OD), oil miscible flowable concentrate (oil miscible suspension) (OF), oil miscible liquid (OL), suspension concentrate (SC), suspoemulsion (SE), soluble concentrate (SL), water dispersible granule (WG or WDG), water soluble granule (SG), water soluble powder (SP), wettable powder (WP), a mixed formulation of CS and SC (ZC), a mixed formulation of CS and SE (ZE), a mixed formulation of CS and EW (ZW), Granule (GR)/Soil Applied Granules (SAG), and Controlled release granules (CR).

In an embodiment, the present disclosure relates to a process of preparing the composition or formulation comprising of chitosan, neem oil, N-(phenylthio) phthalimide (NPP); and optionally agriculturally acceptable excipients.

In an embodiment, the process may comprise the steps of milling, blending, drying, packaging, combinations thereof and the like.

In another embodiment, the present invention relates to a process of preparation of the insecticidal formulation comprising the steps of:
a) adding chitosan in 1-3% acetic acid and stirring the mixture for over-night at room temperature (25-30° C.) to obtain chitosan solution;
b) dissolving N-(phenylthio) phthalimide in dimethyl sulfoxide (DMSO) and then adding to the chitosan solution obtained in step a);
c) adding neem oil to the solution of step b) and stirring the solution until mixture is homogenous at room temperature (25-30° C.) to obtain a mixture;
d) adding polyanionic cross-linking agent dropwise to the mixture of step c) and stirring the mixture until it is homogenized at room temperature (25-30° C.) to obtain formulation solution; and
e) sonicating the solution obtained in step d) as required to obtain a nanoparticle solution of insecticidal composition.

In another embodiment, the present disclosure relates to a method of controlling insects, pests and mites by application of an effective amount of a composition or formulation comprising of chitosan, neem oil, N-(phenylthio) phthalimide (NPP); and optionally agriculturally acceptable excipients.

In another embodiment, the present invention relates to a process of preparation of the insecticidal formulation comprising the steps of:
a) adding 0.89-1.10% by weight of chitosan in 1-3% acetic acid and stirring the mixture for over-night at room temperature (25-30° C.) to obtain chitosan solution;
b) dissolving N-(phenylthio) phthalimide 0.025% and 0.5% in 200 μl dimethyl sulfoxide (DMSO) and then adding to the chitosan solution obtained in step a);
c) adding 0.09-0.5% neem oil to the solution of step b) and stirring the solution until mixture is homogenous at room temperature (25-30° C.) to obtain a mixture;
d) adding 10 ml of polyanionic cross-linking agents like sodium tripolyphosphate, sodium pyrophosphate, tetra polyphosphate, octapolyphosphate, hexametaphosphate, sodium alginate, k-carrageenan, octyl sulfate, dodecyl sulfate, hexadecyl sulfate, and cetyl-stearyl sulfate dropwise to the mixture of step c) and stirring the mixture until it is homogenized at room temperature (25-30° C.) to obtain formulation solution; and
e) sonicating the solution obtained in step d) as required to obtain a nanoparticle solution of insecticidal composition.

In yet another embodiment, the present disclosure relates to use of the composition or formulation comprising of chitosan, neem oil, N-(phenylthio) phthalimide (NPP); and optionally agriculturally acceptable excipients, for controlling insects, pests and mites.

In an embodiment, the composition or formulation of the present invention can be used to control the insects, pests and mites.

The composition or formulation of the present invention when used for controlling insects, pests and mites can also help improve keeping quality of produce, increase post-harvest life, storage life, and protection from post-harvest losses.

The composition or formulation of the present invention when used for controlling insects, pests and mites can also help increase tolerance to the weather stress, moisture stress.

The dose of composition or formulation of the present invention cannot generally be defined, as it varies depending upon the various conditions such as the mixing ratio of components as disclosed, the type of the formulation, the weather conditions, and the type and the growth stage of the weeds to be controlled. However, for example, the composition is applied in an amount of from 100 to 500 g/ha, preferably from 125 to 250 g/ha.

The insecticidal composition of the present invention optionally may further be mixed with other insecticidal active ingredients, whereby the spectrum of insects to be controlled, the application timing, the insecticidal activity, etc. can be improved to preferred directions in some cases. Such other insecticidal active ingredients (common names, etc.) may, for example, Azadirachtin, Nicotine, Rotenone, Pyrethrins I and II, Ryania, Sabadilla, trans-Cinnamaldeyde, 1,8 cineole, Eugenol, Citronella oil, Thujone, Terthiophene, Osthol, Berberine, Curcumin, Spinoside, Quercetin, Emamectin, Abamectin, glyphosate, Acephate, Deet, Propoxur, Metaldehyde, Boric Acid, Diazinon, Dursban, DDT, Malathion. In a case where salts, alkyl esters, hydrates, different crystal forms and various structural isomers, etc. exist as these compounds, they are, of course, all included, even when not specifically mentioned.

The composition or formulation may be effectively used as a part of overall insecticide resistance management (IRM) strategies in order to help prevent or delay the incidence of resistance.

In yet another aspect, the present invention relates to a method of controlling insects which method comprises applying the composition of the present invention.

While the foregoing describes various embodiments of the disclosure, other and further embodiments of the disclosure may be devised without departing from the basic scope thereof. The invention is not limited to the described embodiments, versions or examples, which are included to enable a person having ordinary skill in the art to make and use the invention when combined with information and knowledge available to the person having ordinary skill in the art.

### EXAMPLES

The present invention is further explained in the form of following examples. However, it is to be understood that the following examples are merely illustrative and are not to be taken as limitations upon the scope of the invention. Unless defined otherwise, all technical and scientific terms used herein have the same meaning as commonly understood to one of ordinary skill in the art to which this disclosure belongs. Although methods and materials similar, or equivalent to those described herein can be used in the practice of the disclosed methods and compositions, the exemplary methods, devices, and materials are described herein. It is to be understood that this disclosure is not limited to particular methods, and experimental conditions described, as such methods and conditions may apply.

The insect culture for the purpose of the present invention was obtained from ICAR-National Bureau of Agricultural Insect Resources, Bengaluru. The chitosan and Casein were obtained from Sigma and neem oil is obtained from T-Stanes & company limited. The Tomato plants (Pusa ruby variety) and Bengal gram obtained from ICAR—Indian Agricultural Research Institute, Pusa, New Delhi and Samarat respectfully. Yeast Extract, sorbic acid, streptomycin, Ascorbic acid, cholesterol, and agar-agar were obtained from Himedia. The Multivitamin capsule is obtained from GSK, and Vitamin E capsule were obtained from Nukind Healthcare.

### Example 1: Preparation of Insecticidal Formulation (for Spraying in Solution Form)

| Ingredients | Weight % |
|---|---|
| NPP (N-(phenylthio)phthalimide) | 0.1 |
| Neem oil | 0.1 |
| DMSO | 0.4 |
| Sodium tripolyphosphate | 0.4 |
| Chitosan | 0.9 |
| Deionized water | 98.1% |
| Total | 100 |

Chitosan (0.3 g) was added and dissolved in 2% acetic acid by stirring the mixture over-night at room temperature to obtain chitosan solution. To the chitosan solution, 0.1% N-(phenylthio) phthalimide dissolved in DMSO was added to obtain a solution. to the solution, 0.1% neem oil was added and stirred until the resulting mixture was homogenized. Polyanionic cross-linking agent, sodium tripolyphosphate was added drop wise to the mixture and stirred at room temperature until the mixture is homogenized to obtain a formulation solution. The formulation solution was sonicated to obtain the insecticidal composition which is a formulation comprising nanoparticles and proceeded for characterization of nanoparticles.

### Example 2: Effect of the Composition of Present Invention

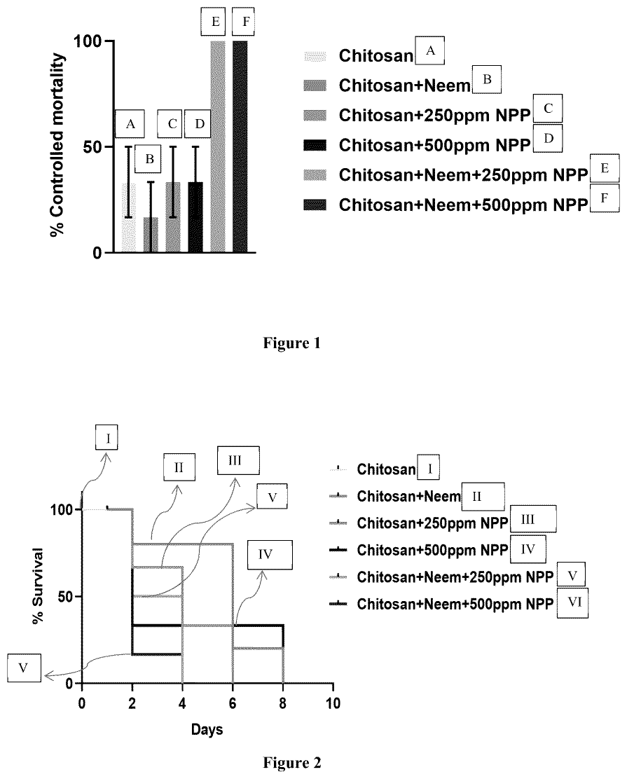

The insect feeding bioassay study was carried out on Spodoptera frugiperda using chitosan nanoparticle and neem formulation along with 250 ppm and 500 ppm NPP. The insects were fed with only chitosan nanoparticles, chitosan+neem nanoparticles, chitosan+NPP nanoparticles and chitosan+neem+NPP nanoparticles. The formulation/insecticidal composition (chitosan nanoparticles+neem+NPP) was found to be effective at 250 ppm and 500 ppm. As observed in FIG. 1, 100% mortality was observed in NPP along with chitosan nanoparticles and neem compared to control. Also, NPP along with chitosan showed mortality greater than control. Thus, formulation made NPP more effective against lepidopteran insects. FIG. 2 depicts the Kaplan-Meier survival analysis graph indicating the survival of insects along the time of assay. Here, the insects that were treated with NPP in combination with neem and chitosan nanoparticles showed least survival of around 4 days. The insects treated with only chitosan and NPP formulation showed survival up to 8 days. Thus, the insecticidal formulation of the present invention is highly effective against Helicoverpa armigera, Spodoptera frugiperda and other lepidopteran species.

### Example 3: Body Weight Study

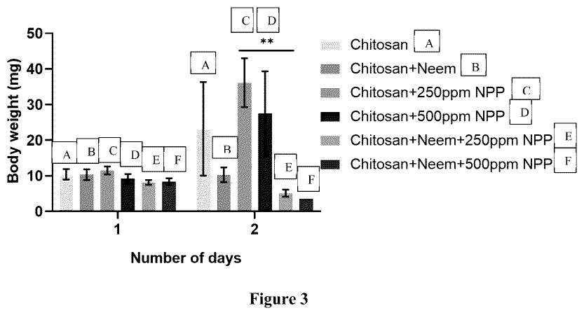

The insect body weight study was carried out on H. armigera larvae. The efficacy of the formulation of the present invention was assessed by feeding H. armigera larvae on formulation painted leaves. As observed in FIG. 3, there was a significant difference in body weight when the formulation chitosan+neem+250 ppm NPP was fed, as compared to chitosan+250 ppm NPP after 24 hours. This indicated that neem indeed acted synergistically with NPP and chitosan and affected H. armigera larvae. Addition of neem with chitosan and NPP in general enhanced the negative effect on H. armigera.

### Advantages of Present Invention

The present disclosure provides effective, ecofriendly and synergistic insecticidal composition.
The insecticidal composition of the present disclosure controls the pests or insects that are resistant to current existing synthetic insecticide.
The present disclosure provides an insecticidal composition with lower probability of acquiring resistance.

I/We claim:

1. An insecticidal composition comprising:
a) N-(phenylthio) phthalimide (NPP);
b) Dimethyl sulphoxide (DMSO);
c) Sodium tripolyphosphate;
d) chitosan;
e) neem oil; and
f) optionally agriculturally acceptable excipients.

2. The insecticidal composition as claimed in claim 1, wherein the composition comprises:
a) N-(phenylthio) phthalimide (NPP) in an amount in a range of 0.025% to 0.11% by total weight of the composition;
b) DMSO and sodium tripolyphosphate in an amount in a range of 0.4 to 0.5% by total weight of the composition;
c) chitosan present in an amount in a range of 0.89% to 1.10% by total weight of the composition;
d) neem oil present in an amount in a range of 0.09% to 1.5% by total weight of the composition; and
e) optionally agriculturally acceptable excipients.

3. The insecticidal composition as claimed in claim 1, wherein the composition further comprises water in sufficient quantity.

4. The insecticidal composition as claimed in claim 1, wherein the composition comprises:
a) N-(phenylthio) phthalimide (NPP) in an amount of 0.1% by total weight of the composition;
b) DMSO and sodium tripolyphosphate in an amount in a range of 0.4 to 0.5% by total weight of the composition;
c) chitosan in an amount of 0.1% by total weight of the composition;
d) neem oil in an amount in a range of 1% by total weight of the composition; and
e) optionally agriculturally acceptable excipients.

5. The insecticidal composition as claimed in claim 1, wherein the composition is a nanoparticle solution.

6. The insecticidal composition as claimed in claim 1, wherein the composition further comprises cross-linking agents selected from the group consisting of sodium tripolyphosphate, sodium pyrophosphate, tetra polyphosphate, octapolyphosphate, hexametaphosphate, sodium alginate, k-carrageenan, octyl sulfate, dodecyl sulfate, hexadecyl sulfate, and cetyl-stearyl sulfate.

7. The insecticidal composition as claimed in claim 1, wherein the composition is in the form of emulsifiable concentrate (EC), emulsion, water in oil (EO), emulsion, oil in water (EW), capsule suspension (CS), dispersible concentrate (DC), jambo balls or bags (bags in water soluble pouch), micro-emulsion (ME), oil dispersion (OD), oil miscible flowable concentrate (oil miscible suspension) (OF), oil miscible liquid (OL), suspension concentrate (SC), suspoemulsion (SE), soluble concentrate (SL), water dispersible granule (WG or WDG), water soluble granule (SG), water soluble powder (SP), wettable powder (WP), a mixed formulation of CS and SC (ZC), a mixed formulation of CS and SE (ZE), a mixed formulation of CS and EW (ZW), granule (GR)/soil applied granules (SAG), and controlled release granules (CR).

8. A process for preparation of the insecticidal composition as claimed in claim 1, wherein the process comprises the step of:
a) adding chitosan to 1-3% acetic acid and stirring for over-night at room temperature (25-30° C.) to obtain a chitosan solution;
b) dissolving N-(phenylthio) phthalimide in dimethyl sulfoxide (DMSO) and then adding to the chitosan solution obtained in step a) to obtain a solution;
c) adding neem oil to the solution of step b) and stirring the solution at room temperature (25-30° C.) to obtain a homogenous mixture;
d) adding a polyanionic cross-linking agent dropwise to the homogenous mixture of step c) and stirring the mixture at room temperature (25-30° C.) to obtain a formulation solution; and
e) sonicating the formulation solution obtained in step d) as required to obtain a nanoparticle solution of insecticidal composition.

9. The process as claimed in claim 8, wherein the polyanionic cross-linking agent is selected from the group consisting of sodium tripolyphosphate, sodium pyrophosphate, tetra polyphosphate, octapolyphosphate, hexametaphosphate, sodium alginate, k-carrageenan, octyl sulfate, dodecyl sulfate, hexadecyl sulfate, and cetyl-stearyl sulfate.

10. A method of controlling insects, pests, and mites, wherein the method comprises applying the composition as claimed in claim 1.
